(19) United States
(12) Patent Application Publication
(10) Pub. No.: US 2023/0041908 A1
(43) Pub. Date: Feb. 9, 2023

(54) IMAGE PROCESSING APPARATUS, NON-TRANSITORY COMPUTER READABLE MEDIUM, AND IMAGE PROCESSING METHOD

(71) Applicant: FUJIFILM Business Innovation Corp., Tokyo (JP)

(72) Inventor: Hisao KOMAZAWA, Kanagawa (JP)

(73) Assignee: FUJIFILM Business Innovation Corp., Tokyo (JP)

(21) Appl. No.: 17/537,427

(22) Filed: Nov. 29, 2021

(30) Foreign Application Priority Data
Aug. 3, 2021 (JP) 2021-127325

(51) Int. Cl. G06F 3/12

(52) U.S. Cl. CPC G06F 3/1251; G06F 3/1208; G06F 3/1242

(57) ABSTRACT

An image processing apparatus includes a processor configured to: in response to a prior print instruction, impose multiple pieces of prior image data to a subset of multiple imposition regions of a continuous paper sheet that is enabled to be imposed with the prior image data in response to the prior print instruction; and in response to a subsequent print instruction, impose subsequent image data to an unplanned region that is not imposed with the prior image data, from among the imposition regions serving as targets of imposition after the prior print instruction.

### CROSS-REFERENCE TO RELATED APPLICATIONS

This application is based on and claims priority under 35 USC 119 from Japanese Patent Application No. 2021-127325 filed Aug. 3, 2021.

### BACKGROUND

### (i) Technical Field

The present disclosure relates to an image processing apparatus, a non-transitory computer readable medium, and an image processing method.

### (ii) Related Art

Japanese Unexamined Patent Application Publication No. 2018-94785 discloses a roll-paper printer that prints a roll paper sheet (continuous paper sheet) in response to a print instruction. The roll-paper printer prints not only an object in a region of the roll paper sheet in response to a prior print instruction but also an object of a subsequent print instruction in a margin region of the roll paper sheet excluding the region of the roll paper sheet for the object responsive to the prior print instruction.

In image processing apparatuses, multiple pieces of prior image data may be imposed to multiple imposition regions on a continuous paper sheet in response to a prior print instruction. The imposition region in this case signifies a region of the continuous paper sheet where the prior image data responsive to the prior print instruction may be imposed. For example, in response to the prior print instruction to print multiple physical pages, pieces of the prior image data responsive to the physical pages are respectively imposed to the imposition regions.

Depending on contents and user settings in the prior print instruction or a combination of multiple prior print instructions, an unplanned region not imposed with the prior image data may occur on the continuous paper sheet. The unplanned region has a concept different from that of a margin area excluding a region for the prior image data. The unplanned region is a region that could be imposed with the prior image data but is not actually imposed with the prior image data.

Referring to FIG. 6, prior image data related to jobs 1 through 3 (pages 1 through 5 for job 1, pages 1 and 2 for job 2, and page 1 for job 3) as the prior print instruction on the continuous paper sheet are imposed. With the prior image data imposed as illustrated in FIG. 6, broken-outline box imposition regions are regions that are enabled to be imposed with the prior image data but are not actually imposed with the prior image data. In other words, the broken-outline box imposition region is an unplanned region U. A region that is not imposed with the prior image data (for example, an area between an imposition region and an edge of the continuous paper sheet) is a margin M.

Although the unplanned region U is enabled to be imposed with the prior image data, the unplanned region U ends without any final product thereon after a print and cutting process. The unplanned region U thus becomes a waste portion of the continuous paper sheet.

### SUMMARY

Aspects of non-limiting embodiments of the present disclosure relate to making subsequent image data printable in response to a subsequent print instruction after a prior print instruction by using an unplanned region that is not imposed with prior image data from among imposition regions that are enabled to be imposed with the prior image data in response to the prior print instruction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing apparatus including a processor configured to: in response to a prior print instruction, impose multiple pieces of prior image data to a subset of multiple imposition regions serving as regions of a continuous paper sheet that is enabled to be imposed with the prior image data in response to the prior print instruction; and in response to a subsequent print instruction, impose subsequent image data to an unplanned region that is not imposed with the prior image data, from among the imposition regions serving as targets of imposition after the prior print instruction.

### BRIEF DESCRIPTION OF THE DRAWINGS

Exemplary embodiment of the present disclosure will be described in detail based on the following figures, wherein:

FIG. 1 illustrates a configuration of an image processing system of an exemplary embodiment;

FIG. 2 illustrates a configuration of a controller;

FIG. 3 illustrates a concept of a state in which prior image data responsive to a prior job is imposed to a continuous paper sheet;

FIG. 4 illustrates a concept of an imposition possibility attribute specified for an unplanned region;

FIG. 5 is a flowchart illustrating a process flow of the controller; and

FIG. 6 illustrates a concept of a related-art state in which the prior image data responsive to the prior job is imposed to the continuous paper sheet.

### DETAILED DESCRIPTION

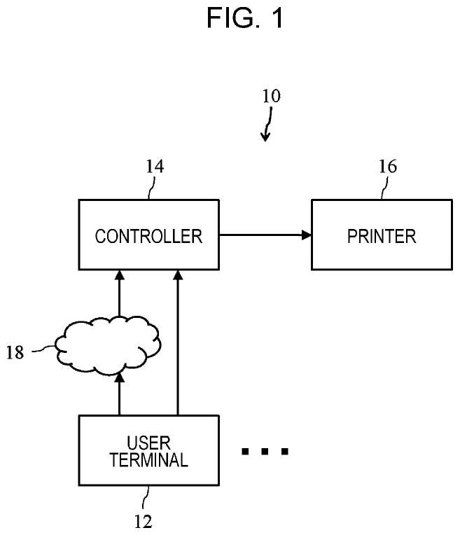

FIG. 1 illustrates a configuration of an image processing system 10 of an exemplary embodiment. The image processing system 10 includes one or more user terminals 12 used by one or more users, a controller 14 serving as an information processing apparatus, and a printer 16. The user terminal 12, controller 14, and printer 16 are interconnected to each other via a communication network, such as a local-area network (LAN).

The user terminal 12 may be a personal computer or a tablet terminal. The user terminal 12 includes a communication interface, such as a network adapter, a display, such as a liquid-crystal panel, an input interface, such as a mouse, a keyboard, or a touch panel, memory, such as hard disk drive (HDD), solid-state drive (SSD), embedded multi-media card (eMMC), read-only memory (ROM), or random-access memory (RAM), and a processor, such as central processing unit (CPU).

The user terminal 12 transmits a print job as a print instruction to the controller 14. The user terminal 12 may transmit the print job to the controller 14 via a local-area network (LAN). If the user terminal 12 is remote from the controller 14, the user terminal 12 may first transmit the print job to a cloud server 18 via a communication network, such as the Internet, and the cloud server 18 may then transmit the print job to the controller 14.

The controller 14 is a computer that performs a variety of operations related to a print process of a printer 16. The controller 14 may be a server computer. In such a case, the controller 14 is connected to the user terminal 12 and printer 16 for communication via a communication network, such as the Internet or a mobile communication line.

In response to the print job from the user terminal 12, the controller 14 generates rasterized data (such as bitmap data) recognizable by the printer 16. The image processing system 10 performs the print process on a continuous paper sheet. As described in greater detail below, the controller 14 imposes, to the continuous paper, image data responsive to the print job from the user terminal 12 (multiple pieces of the image data if the print job indicates printing to multiple physical pages) and generates the rasterized data in accordance with the imposed image data. In this specification, data to be imposed to the continuous paper sheet by the controller 14 is referred to as “image data,” and data that is recognizable by the printer 16 and transmitted to the printer 16 is referred to as “rasterized data.” The controller 14 will be described below in greater detail.

The printer 16 includes a print head, ink cartridge, and paper transport mechanism and prints the rasterized data from the controller 14 onto a print medium. In the exemplary embodiment, the printer 16 is an inkjet printer. Alternatively, the printer 16 may be a laser printer. As described above, the printer 16 performs the print process on a continuous paper sheet that is a long beltlike paper sheet. Specifically, the printer 16 prints the rasterized data for multiple physical pages onto the continuous paper sheet. After the print process, the printed paper sheet is then cut according to each physical page, leading to printed sheets for the multiple physical pages. According to the exemplary embodiment, the printer 16 is a production printer (printer that performs commercial printing). The application of the printer 16 is not limited to the commercial printing.

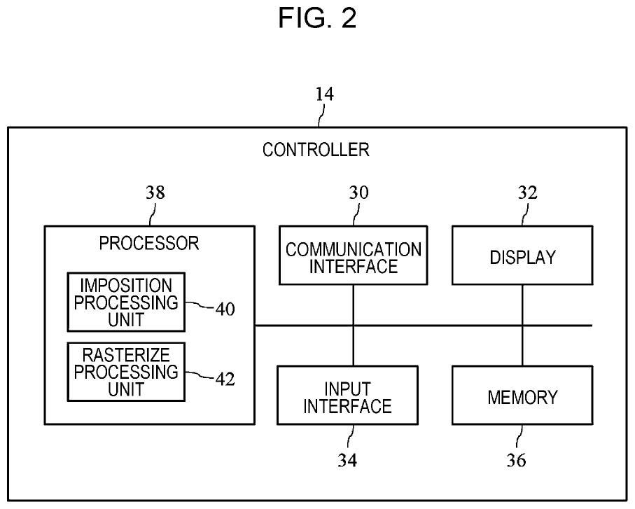

FIG. 2 illustrates a configuration of the controller 14.

A communication interface 30 may include a network adapter. The communication interface 30 has a function of communicating with the user terminal 12 and printer 16 via the LAN. The communication interface 30 receives the print job from the user terminal 12. The communication interface 30 transmits the rasterized data to the printer 16.

The display 32 may include a liquid-crystal panel. The display 32 displays a variety of screens related to the print process, such as a setting screen and a management screen for the input print job. If the controller 14 is a server computer, the display of the user terminal 12 may serve as the display 32.

The input interface 34 may include a touch panel and button. The input interface 34 receives an instruction from a user. Using the input interface 34, the user may provide a startup instruction of the controller 14 (and the printer 16) and an instruction related to the input print job. For example, using the input interface 34, the user may make settings (as described in greater detail below) related to the input print job. The input interface 34 may include a storage medium reader that reads a compact disk (CD) or digital versatile disk (DVD). When the storage medium reader reads a storage medium having stored the print job, the print job may be input to the controller 14. If the controller 14 is the server computer, the input interface of the user terminal 12 serves as the input interface 34.

A memory 36 may include the HDD, SSD, eMMC, ROM, and/or RAM. The memory 36 stores an image processing program that causes each element of the controller 14 to operate. The memory 36 also temporarily stores the input print job and the rasterized data that has been generated in response to the print job.

A processor 38 refers to a processor in a broad sense and includes at least one of a general processor (e.g., CPU: Central Processing Unit) and a dedicated processor (e.g., GPU: Graphics Processing Unit, ASIC: Application Specific Integrated Circuit, FPGA: Field Programmable Gate Array, or programmable logic device). The processor 38 encompasses one processor or plural processors in collaboration which are located physically apart from each other but may work cooperatively. Referring to FIG. 2, in accordance with the image processing program stored on the memory 36, the processor 38 works as an imposition processing unit 40 and rasterize processing unit 42.

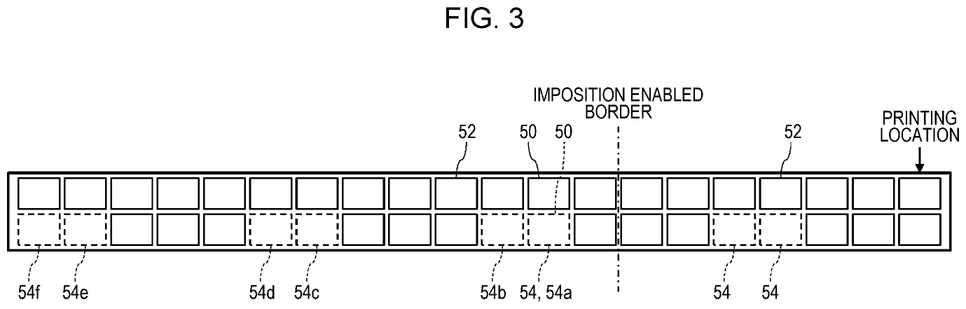

The imposition processing unit 40 performs an imposition operation in response to the input print job to impose the image data of the print job onto the continuous paper sheet. The image data of the print job corresponds to an image that the print job has provided an instruction to print. FIG. 3 illustrates a concept of a state in which the image data of the print job is imposed. Referring to FIG. 3, the image data is imposed to the continuous paper sheet from the leading edge thereof (a right end in FIG. 3) to the trailing edge (a left end in FIG. 3). FIG. 3 illustrates the continuous paper sheet in a simple form. In practice, the continuous paper sheet is longer and the number of pieces of the image data higher than the number of pieces of the image data illustrated in FIG. 3 may be imposed to one continuous paper sheet. The imposition of the image data signifies that the imposition processing unit 40 determines a print location of the image data of the print job on the continuous paper sheet in the memory 36.

Specifically, the imposition processing unit 40 imposes the image data of the print job to an imposition region 50. The imposition region 50 is a region that is defined on the continuous paper sheet and imposed with the image data of the print job. Multiple imposition regions 50 may be defined on the continuous paper sheet.

The area of the imposition region 50 is determined by the size of one physical page after the cutting process. In the printer 16 that prints a physical page having a specific size, the area of the imposition region 50 may be preset or may be determined in accordance with the print job (the size of the physical page after the cutting process set in the print job). Referring to FIG. 3, the imposition regions 50 are arranged in two rows on the continuous paper sheet and equal to each other in size.

The imposition processing unit 40 may automatically perform an imposition operation in response to the print job. The imposition processing unit 40 may also perform the imposition operation in response to an instruction from the user. In such a case, the user may select an imposition destination of each piece of the image data of the print job from the imposition regions 50 defined on the continuous paper sheet.

Referring to FIG. 3, an imposition region 50 defined by a solid-outline box is an imposition region 50 that is imposed with the image data of the print job. The imposition region 50 imposed with the image data of the print job is referred as a planned region 52. An imposition region 50 not imposed with the image data may occur in response to contents of the print job or an instruction from the user, or because multiple pieces of the image data are imposed to multiple print jobs. According to the exemplary embodiment, in particular, if the imposition regions 50 are arranged in multiple rows on the continuous paper sheet, an imposition region 50 not imposed with the image data may possibly occur. Referring to FIG. 3, the imposition regions 50 defined by the broken-outline boxes are the imposition regions 50 that are not imposed with the image data. An imposition region 50 that is not imposed with the image data of the print job is referred to as an unplanned region 54. If the unplanned region 54 remains not imposed with the image data, the unplanned region 54 becomes a waste of paper after the print process.

The imposition processing unit 40 may impose to the unplanned region 54 image data of a subsequent print job. The imposition operation to the unplanned region 54 will be described below.

The rasterize processing unit 42 performs a rasterize operation to generate rasterized data in accordance with each piece of the image data imposed by the imposition processing unit 40. The rasterize processing unit 42 generates the rasterized data of the image data in accordance with an order of print of the imposed image data. As described above, the leading edge of the continuous paper sheet is the right end in FIG. 3 and the trailing edge of the continuous paper sheet is the left end in FIG. 3 and thus the order of print is in a direction from right to left. Specifically, the right end of the continuous paper sheet is first imposed with the image data and then image data on the left side is successively printed. The rasterize processing unit 42 generates the rasterized data for two pieces of image data (two pieces of the image data vertically arranged) at the right end portion and transmits the rasterized data to the printer 16. The rasterize processing unit 42 generates the rasterized data for the two pieces of image data on a portion to the left of the right end portion and transmits the generated rasterized data to the printer 16. The rasterize processing unit 42 successively repeat this operation from right to left. The printer 16 performs the print process on the rasterized data successively received.

The imposition operation of the image data to the unplanned region 54 performed by the imposition processing unit 40 is described below.

As described above, the unplanned region 54 is created when the imposition processing unit 40 imposes the image data in accordance with the print job. Image data of another job subsequent to the print job is imposed to the unplanned region 54. In the specification, a print job causing the unplanned region 54 is referred to as a prior print job serving as a prior print job instruction. A print job subsequent to the prior print job, specifically, a print job serving as a target of the imposition operation subsequent to the prior print instruction is referred to as a subsequent print job serving as a subsequent print instruction. The subsequent print job may be a job that is input to the controller 14 after the prior print job or a job that is input to the controller 14 at the same time when the prior print job is input. Image data of the prior print job is referred to prior image data and image data of the subsequent print job is referred to as subsequent image data.

The imposition operation of the subsequent image data to the unplanned region 54 is described with reference to FIG. 3. In the state illustrated in FIG. 3, in response to a prior print job (or multiple print jobs), the imposition processing unit 40 has imposed the prior image data of the prior print job to a subset of the imposition regions 50 defined on the continuous paper sheet. The imposition regions 50 with the prior image data imposed thereto are the planned regions 52 denoted by the solid-outline boxes. Out of the imposition regions 50 defined on the continuous paper sheet, imposition regions 50 not imposed with the prior image data are the unplanned region 54 denoted by broken-outline boxes.

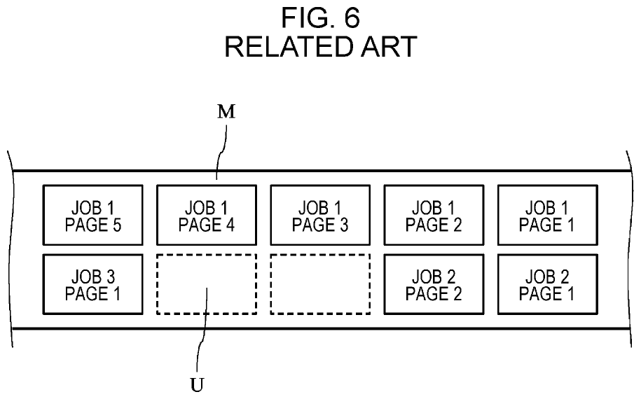

As described above, each unplanned region 54 is enabled to be imposed with the prior image data but is actually not imposed with the prior image data. The unplanned region 54 is thus different in concept from an area that is unable to be imposed with the prior image data (for example, a margin of the continuous paper sheet, such as the margin M in FIG. 6).

The unplanned region 54 is equal in area to at least one of the planned regions 52 serving as the imposition regions 50 imposed with the prior image data. According to the exemplary embodiment, as described above, the imposition regions 50 are equal to each other in size, and each of the planned regions 52 is equal in area to each of the unplanned regions 54.

The prior image data imposed to the planned region 52 may include (blank) prior image data containing no object, in other words, prior image data corresponding to a physical blank page. The physical plank page may serve as a back cover or a mark delineating a group of physical pages. The physical blank page is thus typically widely used in printed matter or print process. If the blank prior image data is imposed to the planned region 52, nothing is naturally printed on the corresponding planned region 52. However, the imposition region 50 is the planned region 52 imposed with the blank prior image data and is not the unplanned region 54.

The subsequent print job may be input to the controller 14 after the prior image data of the prior print job is imposed. The imposition processing unit 40 then analyzes the subsequent print job and determines whether imposing the subsequent image data of the subsequent print job to the unplanned region 54 is possible.

As described above, the rasterize processing unit 42 generates the rasterized data of the image data from right to left in FIG. 3. When the rasterized data has been generated and transmitted to the printer 16, the imposition processing unit 40 is unable to modify the imposition state of the imposition regions 50. For example, as illustrated in FIG. 3, when the printer 16 performs the print process on the prior image data imposed to the imposition regions 50 at the right end, namely, the leading edge of the continuous paper sheet, it is presumed that the prior image data imposed to the imposition regions 50 present down to an imposition enabled border has undergone the generation of the rasterized data and the transmission of the rasterized data to the printer 16. In such a case, the imposition processing unit 40 may be able to impose the subsequent image data of the subsequent print job to only the unplanned regions 54 behind the imposition enabled border (only the unplanned regions 54 to the left of the imposition enabled border).

A determination as to whether the imposition of the subsequent image data to the unplanned region 54 is possible is made depending on the number of physical pages as print results specified by the subsequent print job and the number of unplanned regions 54 enabled to be imposed. For example, in FIG. 3, the number of unplanned regions 54 that are enabled to be imposed, namely, the number of unplanned regions 54 behind the imposition enabled border in the order of print is six (unplanned regions 54a through 54f). If the subsequent print job requests six or less physical pages to be output, the imposition processing unit 40 determines the imposition of the subsequent image data to the unplanned regions 54 is possible.

On the other hand, if the subsequent print job requests seven or more physical pages to be output, the imposition processing unit 40 determines the imposition of the subsequent image data to the unplanned regions 54 is not possible. If a subset of multiple pieces of the subsequent image data of the subsequent print job is imposed to the unplanned regions 54a through 54f, only six pages of the image data are imposed to the unplanned regions 54a through 54f and remaining subsequent image data is imposed to a next continuous paper sheet. According to the exemplary embodiment, multiple pieces of the image data of one print job are not permitted to be printed across multiple continuous paper sheets. For this reason, the imposition processing unit 40 determines that the imposition of the subsequent image data to the unplanned regions 54 is not possible.

An imposition possibility attribute serving as an attribute of the image data enabled to be imposed to each unplanned region 54 may be specified for the unplanned region 54. The imposition processing unit 40 may now determine whether the imposition of the subsequent image data of the subsequent print job to the unplanned region 54 is possible. In this case, if the attribute of the subsequent print job meets the imposition possibility attribute specified for the unplanned region 54, the imposition processing unit 40 determines that the imposition of the subsequent image data of the subsequent print job to the unplanned region 54 is possible.

The imposition possibility attribute of each unplanned region 54 may be specified by the user. Alternatively, the processor 38 may automatically specify the imposition possibility attribute of each unplanned region 54. If there are multiple unplanned regions 54, each unplanned region 54 may have a different imposition possibility attribute.

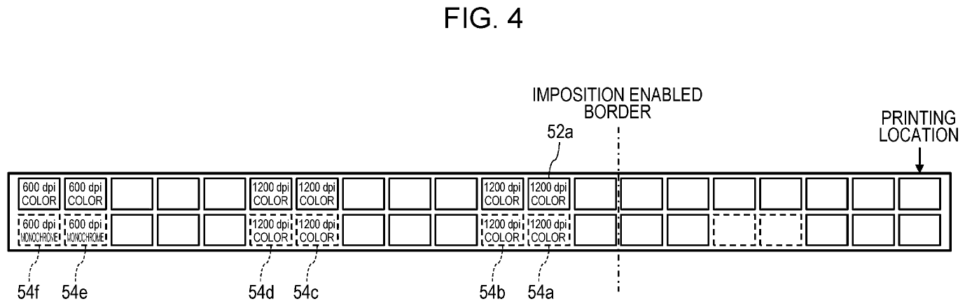

FIG. 4 illustrates the concept of the imposition possibility attributes specified for the unplanned regions 54. For example, a typical imposition possibility attribute may be a print resolution (for example, 1200 dots per inch (dpi)) and color (for example, color or monochrome). Referring to FIG. 4, out of six unplanned regions 54, four unplanned regions 54a through 54d have the imposition possibility attribute of 1200 dpi and color and the remaining two unplanned regions 54e and 54f have 600 dpi and monochrome.

Since a print attribute is unable to be changed in the middle of horizontal scanning during the print process, the imposition possibility attribute of the unplanned region 54 is identical to the attribute of the prior print job corresponding to the prior image data imposed to the planned region 52 that is aligned with the unplanned region 54 in the direction of the horizontal scanning (vertical direction in FIG. 3). For example, if the prior image data of the prior print job requesting the outputting at 1200 dpi and color is imposed to a planned region 52a as illustrated in FIG. 4, the imposition possibility attribute of the unplanned region 54a that is aligned with the planned region 52a in the horizontal scanning direction is identical to the imposition possibility attribute of the prior print job, namely, 1200 dpi and color.

Referring to FIG. 4, if the subsequent print job requests six or less physical pages to be output at 1200 dpi and color as the attribute of the subsequent print job, the imposition possibility attribute of the unplanned regions 54a through 54d (1200 dpi and color) meets the attribute of the subsequent print job but the imposition possibility attribute of the unplanned regions 54e and 54f (600 dpi and monochrome) does not meet the attribute of the subsequent print job. In such a case, since the image data of the subsequent print job is unable to be imposed to the six unplanned regions 54a through 54f, the imposition processing unit 40 determines that the imposition of the subsequent image data to the unplanned regions 54 is not possible.

If the imposition processing unit 40 determines that the imposition of the subsequent image data of the subsequent print job to the unplanned regions 54 is possible, the imposition processing unit 40 imposes the subsequent image data to the unplanned regions 54. Referring to FIG. 3, the imposition processing unit 40 imposes page 1 of the subsequent image data to the unplanned region 54a, page 2 of the subsequent image data to the unplanned region 54b, page 3 of the subsequent image data to the unplanned region 54c, page 4 of the subsequent image data to the unplanned region 54d, page 5 of the subsequent image data to the unplanned region 54e, and page 6 of the subsequent image data to the unplanned region 54f.

Referring to FIG. 3, the unplanned region 54 may be the imposition region 50 that is earlier in the order of print than at least one planned region 52. If such unplanned region 54 is imposed with the subsequent image data, the subsequent image data is printed before at least one piece of the prior image data.

If there are multiple unplanned regions 54, the unplanned regions 54 are not necessarily adjacent to each other. In such a case, if the multiple pieces of subsequent image data are imposed to the unplanned regions 54 and then printed, multiple physical pages related to one subsequent print job may be printed at locations that are not consecutive. In order to easily collect the physical pages related to one print job, the imposition processing unit 40 may include in the subsequent image data (and the prior image data) an identifier (such as a bar code) identifying the corresponding print job and page number. In this way, the physical pages of one print job may be easily collected after printing by referring to the identifier printed together with the image data.

If the imposition processing unit 40 determines that the imposition of the subsequent image data of the subsequent print job to the unplanned region 54 is not possible, the imposition processing unit 40 does not impose the subsequent image data to the unplanned region 54 and puts on hold the imposition of the subsequent image data to the imposition region 50. In such a case, if an unplanned region 54 enabled to be imposed with the held subsequent image data appears as a result of imposing the other subsequent image data, the imposition processing unit 40 imposes the held subsequent image data to the unplanned region 54. Alternatively, the imposition processing unit 40 may impose the held subsequent image data to an imposition region 50 that is later in the order of print than the last planned region 52 imposed with the prior image data.

The rasterize processing unit 42 generates the rasterized data after the imposition processing unit 40 imposes the subsequent image data to the unplanned regions 54. If the subsequent image data is imposed to the unplanned region 54 that is aligned in the horizontal scanning direction with the planned region 52 imposed with the prior image data, the rasterize processing unit 42 generates the rasterized data including a combination of the prior image data and subsequent image data.

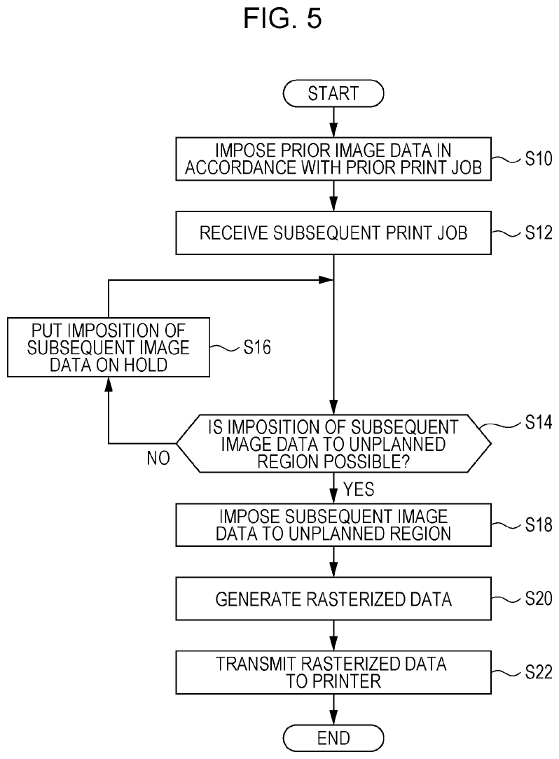

The flow process of the controller 14 is described with reference to a flowchart in FIG. 5.

In step S10, the imposition processing unit 40 imposes the prior image data of the prior print job received by the controller 14 to the imposition region 50 defined on the continuous paper sheet. The prior image data is herein imposed to a subset of the imposition regions 50. As a result, the imposition regions 50 include the planned regions 52 imposed with the prior image data and the unplanned regions 54 not imposed with the prior image data.

In step S12, the controller 14 receives the subsequent print job. As described above, the subsequent print job is simply a job serving as a target of the imposition operation after the prior print job and the prior print job and the subsequent print job may be input at the same time to the controller 14.

In step S14, the imposition processing unit 40 determines whether the imposition of the subsequent image data of the subsequent print job received in step S12 to the unplanned region 54 formed in step S10 is possible. For example, if the number of unplanned regions 54 is equal to or higher than the number of physical pages as print results specified by the subsequent print job, the imposition processing unit 40 determines that the positioning is possible. If the number of unplanned regions 54 is lower than the number of physical pages as print results specified by the subsequent print job, the imposition processing unit 40 determines that the positioning is not possible. Alternatively, as described above, by accounting for the imposition possibility attribute specified for the unplanned region 54, the imposition processing unit 40 may determine whether the imposition of the subsequent print job to the unplanned region 54 is possible. If the imposition processing unit 40 determines that the imposition of the subsequent print job is possible, processing proceeds to step S18. If the imposition processing unit 40 determines that the imposition of the subsequent print job is not possible, processing proceeds to step S16.

In step S16, the imposition processing unit 40 puts on hold the imposition of the subsequent image data of the subsequent print job. The imposition processing unit 40 monitors whether an unplanned region 54 enabled to be imposed with the held subsequent image data appears as a result of imposing another piece of the subsequent image data (step S14 again). If the unplanned region 54 enabled to be imposed with the held subsequent image data appears, processing proceeds to step S18. As described above, the imposition processing unit 40 may impose the held subsequent image data to the imposition region 50 that is later in the order of print than the last planned region 52 imposed with the prior image data.

In step S18, the imposition processing unit 40 imposes the subsequent image data to the unplanned region 54.

In step S20, the rasterize processing unit 42 generates the rasterized data in accordance with the prior image data and subsequent image data imposed by the imposition processing unit 40.

In step S22, the rasterize processing unit 42 transmits the rasterized data generated in step S20 to the printer 16. The printer 16 performs the print process in accordance with the received rasterized data.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising a processor configured to:
in response to a prior print instruction, impose a plurality of pieces of prior image data to a subset of a plurality of imposition regions of a continuous paper sheet that is enabled to be imposed with the prior image data in response to the prior print instruction; and
in response to a subsequent print instruction, impose subsequent image data to an unplanned region that is not imposed with the prior image data, from among the imposition regions serving as targets of imposition after the prior print instruction.

2. The image processing apparatus according to claim 1, wherein the unplanned region is earlier in an order of print than the imposition region imposed with the prior image data.

3. The image processing apparatus according to claim 1, wherein the plurality of pieces of the prior image data imposed to the imposition regions comprise a piece of the prior image data corresponding to a physical blank page.

4. The image processing apparatus according to claim 2, wherein the plurality of pieces of the prior image data imposed to the imposition regions comprise a piece of the prior image data corresponding to a physical blank page.

5. The image processing apparatus according to claim 1, wherein the unplanned region is equal in area to the imposition region imposed with the prior image data.

6. The image processing apparatus according to claim 2, wherein the unplanned region is equal in area to the imposition region imposed with the prior image data.

7. The image processing apparatus according to claim 3, wherein the unplanned region is equal in area to the imposition region imposed with the prior image data.

8. The image processing apparatus according to claim 4, wherein the unplanned region is equal in area to the imposition region imposed with the prior image data.

9. The image processing apparatus according to claim 1, wherein the processor is configured to:
if the subsequent print instruction is received, determine whether imposing the subsequent image data to the unplanned region is possible; and
if the imposing of the subsequent image data to the unplanned region is not possible, not impose the subsequent image data to the unplanned region but put on hold the imposing of the subsequent image data.

10. The image processing apparatus according to claim 9, wherein an imposition possibility attribute is specified for the unplanned region as an attribute of image data that is enabled to impose to the unplanned region, and
wherein the processor is configured to, if an attribute of the subsequent print instruction meets the imposition possibility attribute, determine that the imposing of the subsequent image data of the subsequent print instruction to the unplanned region is possible.

11. A non-transitory computer readable medium storing a program causing a computer to execute a process, the process comprising:
in response to a prior print instruction, imposing a plurality of pieces of prior image data to a subset of a plurality of imposition regions of a continuous paper sheet that is enabled to be imposed with the prior image data in response to the prior print instruction; and
in response to a subsequent print instruction, imposing subsequent image data to an unplanned region that is not imposed with the prior image data, from among the imposition regions serving as targets of imposition after the prior print instruction.

12. An image processing method comprising:
in response to a prior print instruction, imposing a plurality of pieces of prior image data to a subset of a plurality of imposition regions of a continuous paper sheet that is enabled to be imposed with the prior image data in response to the prior print instruction; and
in response to a subsequent print instruction, imposing subsequent image data to an unplanned region that is not imposed with the prior image data, from among the imposition regions serving as targets of imposition after the prior print instruction.
